(19) United States
(12) Patent Application Publication
(10) Pub. No.: US 2002/0159487 A1
(43) Pub. Date: Oct. 31, 2002

(54) Chirp-free directly modulated light source with integrated wavelocker

(75) Inventors: Robert Thornton, Los Altos, CA (US); John Epler, Milpitas, CA (US); Doug Stinson, Fremont, CA (US)

Correspondence Address: Timothy A. Brisson, Sierra Patent Group, Ltd., P.O. Box 6149, Stateline, NV, 89449, US

(73) Assignee: Siros Technologies, Inc.

(21) Appl. No.: 09/910,538

(22) Filed: Jul. 20, 2001

Related U.S. Application Data
(63) Continuation-in-part of application No. 09/817,362, filed on Mar. 20, 2001.
(60) Provisional application No. 60/263,060, filed on Jan. 19, 2001.

(51) Int. Cl. H01S 3/098; H01S 3/10; H01S 3/08

(52) U.S. Cl. 372/26; 372/18

(57) ABSTRACT

A light source is disclosed for use optical communications systems. In one aspect, a gain region defined by a first and second mirror is provided having a corresponding resonant mode, and an external cavity defined by a third mirror and the second mirror is also provided having a plurality of resonant modes. The second mirror is configured such that one of the external cavity resonant modes is selected. The single channel laser has wavelength precision sufficient to eliminate the need for an external wavelocker, and has an external cavity capable of being directly modulated in a chirp-free manner.

### RELATED APPLICATIONS

This application is a continuation in part of U.S. application Ser. No. 09/817,362, filed Mar. 20, 2001. This application also claims the benefit of U.S. Provisional Applications No. 60/263,060, filed Jan. 19, 2001; and 60/xxx,xxx, filed Jul. 9, 2001, U.S. Express Mail No. ET161056125US, Attorney Docket No. Siros-034P.

### BACKGROUND

1. Field of the Disclosure

The disclosure relates generally to lasers, and in particular, to Vertical Cavity Surface Emitting Lasers (VCSEL).

2. The Prior Art

Background

Vertical Cavity Surface Emitting Lasers (VCSELs) are well known in the art (see, e.g. Wilmsen, Temkin and Coldren, et. al. “Vertical Cavity Surface Emitting Lasers”, 2nd Edition). They have found extensive use in short-distance (<1 km) and moderate speed (<=1 Gb/s) data communications applications.

VCSEL have several advantages over their main competitor, edge emitting lasers. For example, VCSELs can be tested in wafer-form. This is less expensive than testing individual devices, as must be done with edge emitters. Wafer testing also allows defective devices to be culled early in the process, before additional fabrication expenses have been invested. Furthermore, VCSELs emit a beam of light whose intensity profile is circular, rather than elliptical, as is the case for edge emitters. Circular beams couple more efficiently into optical fibers. Moreover, VCSEL manufacturing yield is higher than edge emitter yield because the critical mirrors are formed using semiconductor manufacturing processes rather than mechanical cleaving of the wafer. Finally, VCSELs are more reliable because of a lower density of defects in the mirrors.

However, for longer distance and higher speed telecommunications applications, edge-emitting lasers remain dominant for several reasons. For example, edge emitters can be designed to operate at a wavelength of 1550 nm (as opposed to 850 nm which is typical for VCSELs). This wavelength suffers much less attenuation as it propagates through optical fiber, enabling longer distance transmission. Furthermore, edge emitters can be designed to have high power—40 mW or more—compared to a few mW for VCSELs. This high power also enables longer distance transmission. Finally, edge emitters produce light of a single polarization. This characteristic can be critical where the light is passed through polarization-sensitive equipment.

Improvements in VCSEL technology has solved some of the disadvantages listed above. For example, VCSELs have been developed which emit light at a wavelength of 1550 nm (see, e.g. J. Boucart, et. al. “1-mW CW-RT Monolithic VCSEL at 1.55 mm”, IEEE Photonics Technology Letters, Vol. 11, No. 6, June 1999).

In conventional laser technology for dense wavelength division multiplexing (DWDM) applications, increasingly dense channel spacing results in higher demands on the precision with which a laser maintains operation at a specifically assigned frequency. Because laser devices are subject to drift in frequency as a result of aging, temperature and other operational factors, it is often necessary to provide an element equivalent to an absolute frequency standard in order to monitor the frequency of the laser and provide an active feedback control signal to maintain the target frequency for the laser. The device which provides this monitoring function in current DWDM is known as a wavelocker.

The wavelocker is typically incorporated into a system as shown in FIG. 1. The system 10 typically comprises a light source 20 generally including a laser diode coupled to a temperature control device. The output of the light source is provided at an output port 30, where a portion of the output signal is provided to a photo-detector 40 through an etalon. The photo-detector/etalon combination 40 is configured to precisely sense the output wavelength of the light source 20, and provide an input to an electronic feedback circuitry 50. Based upon the sensed input, the feedback circuitry 50 makes the appropriate corrections to the light source 20, generally be adjusting the temperature. Thus, the photo-detector/etalon 40 and the feedback circuitry 50 function as a wavelocker for the light source 20.

The etalon portion of a wavelocker typically consists of a pair of parallel mirrors that have a specifically fabricated spacing, such that the resonant frequencies of the resulting Fabry-Perot cavity are precisely controlled to have a predetermined relationship to the wavelengths used in DWDM systems as specified by the International Telecommunications Union (ITU)

A particular problem in conventional systems such as FIG. 1 occurs when the light source is directly modulated. When a laser is directly modulated, “chirp” may occur. Chirp is defined as a change in the frequency of the light during the light pulse. The change in index of refraction and temperture of the laser material between the “on” and “off” state is responsible for chirp. Chirp is undesirable as it limits the distance over which the resulting optical signal can be propagated before dispersion becomes excessive.

### SUMMARY

A light source is disclosed for use in optical communications systems. In one aspect, a gain region defined by a first and second mirror is provided having a corresponding resonant mode, and an external cavity defined by a third mirror and the second mirror is also provided having a plurality of resonant modes. The second mirror is configured such that one of the external cavity resonant modes is selected. The laser has wavelength precision sufficient to eliminate the need for an external wavelocker, and is capable of being directly modulated in an essentially chirp-free manner.

### BRIEF DESCRIPTION OF THE DRAWING FIGURES

FIG. 1 is a prior art diagram of a light source with an external wavelocker;

FIG. 2 is conceptual diagram of one aspect of a disclosed light source;

FIG. 4 is a more detailed conceptual diagram of one aspect of a disclosed light source;

FIG. 5 is a plot of the resonant modes of one aspect of a disclosed system;

FIG. 6 is a plot of various gain cavity responses and resonant modes of one aspect of a disclosed system;

FIG. 7 is a plot showing how a gain cavity response may be adjusted to select one resonant mode according to one aspect of a disclosed system;

FIG. 8 is schematic diagram of a light source configured according to the present disclosure without an external wavelocker;

FIG. 9 is a plot shows the emission spectrum both unmodulated and under pulsed modulation for a prior art VCSEL; and

FIG. 10 is a plot shows the emission spectrum both unmodulated and under pulsed modulation for a single-channel light source configured according to the present disclosure.

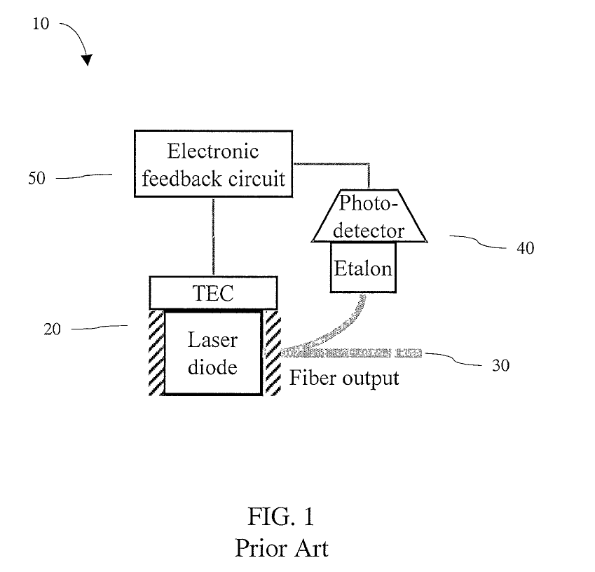

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

The following references are hereby incorporated by reference into the detailed description of the preferred embodiments, and also as disclosing alternative embodiments of elements or features of the preferred embodiment not otherwise set forth in detail above or below or in the drawings. A single one or a combination of two or more of these references may be consulted to obtain a variation of the preferred embodiment described above. In this regard, further patent, patent application and non-patent references, and discussion thereof, cited in the background and/or elsewhere herein are also incorporated by reference into the detailed description with the same effect as just described with respect to the following references:

U.S. Pat. Nos. 5,347,525, 5,526,155, 6,141,127, and 5,631,758;

Wilmsen, Temkin and Coldren, et al., “Vertical Cell Surface Emitting Lasers, 2nd edition;

Ulrich Fiedler and Karl Ebeling, “Design of VCSELs for Feedback Insensitive Data Transmission and External Cavity Active Mode-Locking”, IEEE JSTQE, Vol. 1, No. 2 (June 1995); and

J. Boucart, et al., 1-mW CW-RT Monolithic VCSEL at 1.55 mm, IEEE Photonics Technology Letters, Vol. 11, No. 6 (June 1999).

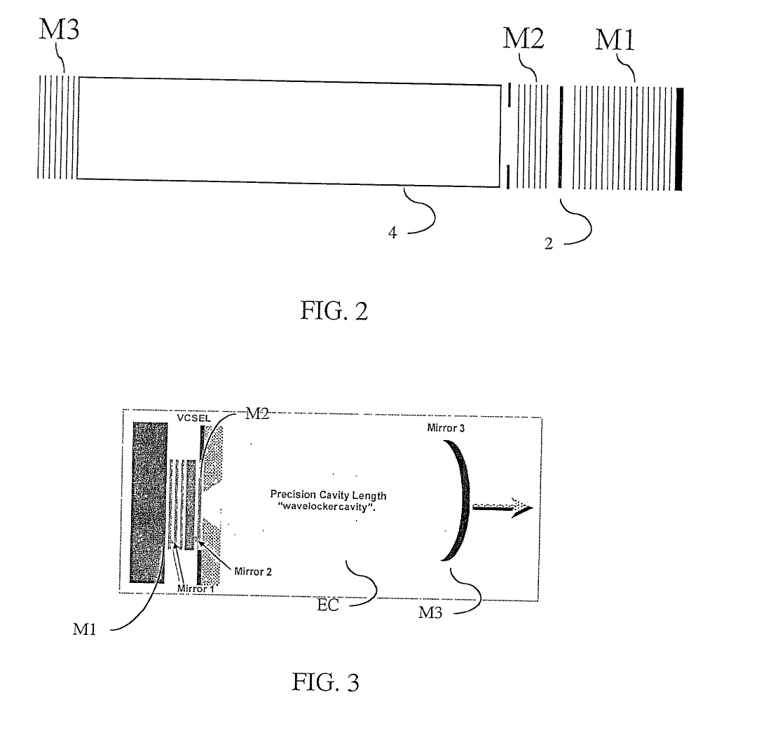

FIG. 2 is conceptual diagram of a light source and illustrates a three-mirror composite-cavity VCSEL configured in accordance with the teachings of this disclosure. The light source includes epitaxially-grown mirrors M1 and M2, and an external mirror M3. In operation, mirror M3 controls the laser emission frequency and provides coupling of the laser energy. The combination of these mirrors defines two cavities: the VCSEL resonant cavity 2, or gain cavity 2, defined by M1 and M2; and an external cavity 4 defined by M2 and M3.

FIG. 3 is another conceptual diagram of a light source and further illustrates a three-mirror composite-cavity VCSEL configured in accordance with the teachings of this disclosure. FIG. 3 further illustrates the integration of a VCSEL into an external cavity which provides for a supplemental reflection mirror M3 relative to the reflectivity value provided by the VCSEL mirror M2.

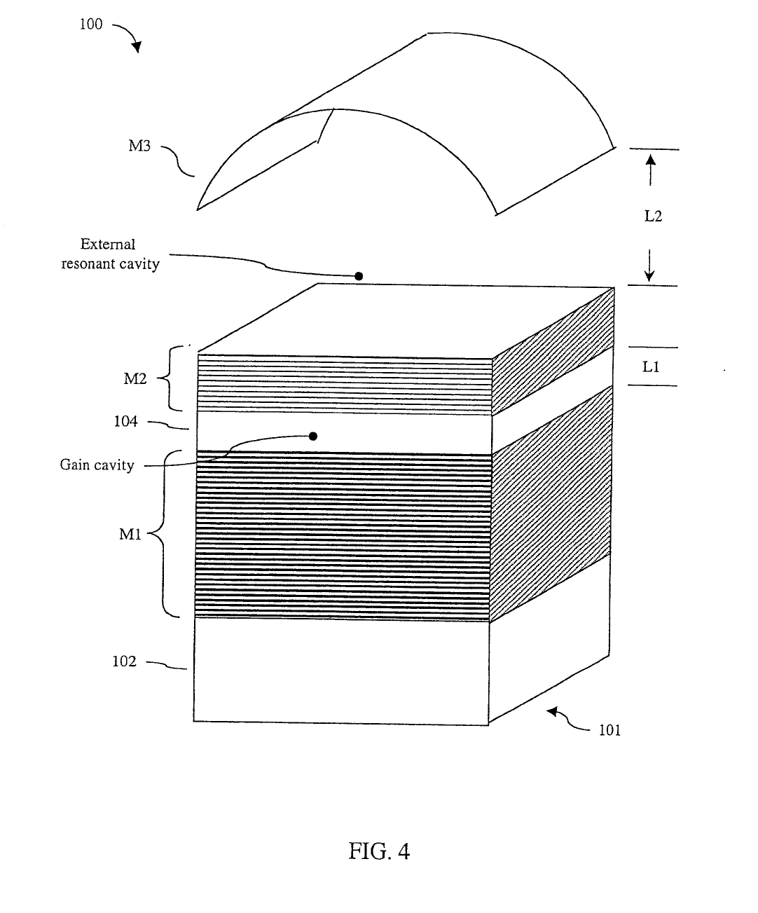

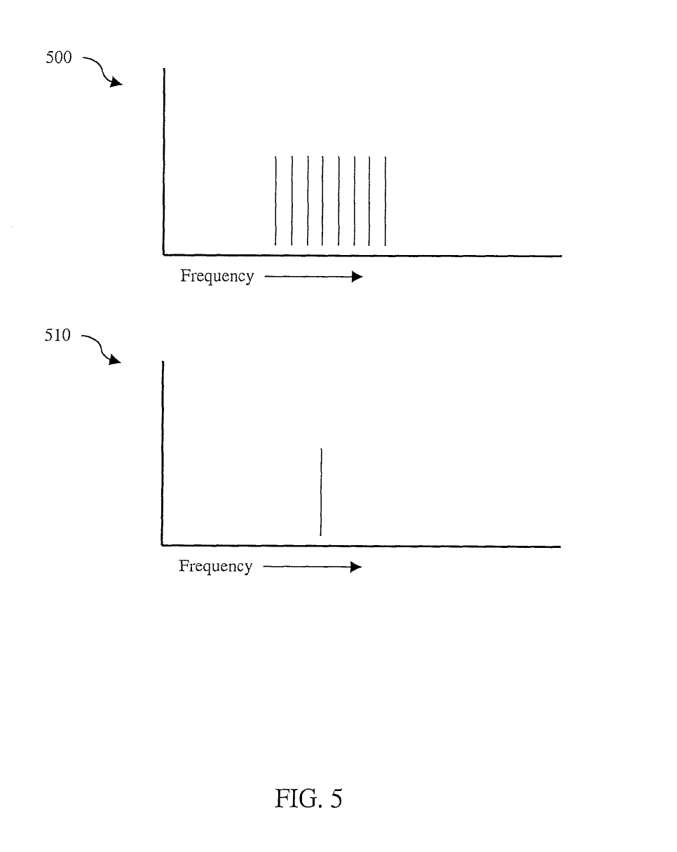

FIG. 4 is a more detailed conceptual diagram of one aspect of a disclosed light source 100. The light source 100 may include a VCSEL 101 having a substrate 102 for reflecting light at normal indices. The substrate 102 may be formed from materials known in the art such as Gas or InP depending on the desired wavelength.

On top of the substrate 102 a mirror M1 is formed. The layers of M1 may be formed epitaxially using techniques known in the art. If the substrate 102 comprises GAs, then the layers of M1 may be formed from alternating layers of AlGAs/GaAs for use in the wavelength range of 780-980 nm. Alternatively, if the substrate 102 comprises InP, the layers of M1 may formed of alternating layers of InGAlAs/InP for use in the wavelength range of 1300-1700 nm.

An active layer 104 for amplifying light is then grown on M1. The active layer 104 may comprise a quantum well active layer fashioned from the same material as M1. The active layer 104 may be formed to a length L1. The active layer 104 will have a gain response and a nominal peak frequency associated therewith. In one aspect of a disclosed light source, the active layer 104 may have a nominal peak frequency of 1550 nm. The nominal peak frequency is typically a function of variables such as current or temperature.

A mirror M2 may then be grown on the active layer 104 using techniques similar to M1.

The light source 100 may further include a mirror M3 disposed a distance L2 from the upper surface of M2.

A light source 100 is thus formed including a VCSEL 101 and an external mirror M3 wherein several alternative designs and variations may be possible. The light source 100 may be described in terms of the distance L1 between mirrors M1 and M2 forming a external cavity and the distance L2 between mirrors M2 and M3 forming a gain cavity.

In general, the cavity length of the external cavity may be greatly extended compared with a conventional VCSEL device. The external cavity may be, e.g., between a few hundred microns and several millimeters, and is particularly preferred around 2-3 mm in physical length for a mode-spacing of 50 GHz. For example, at 50 GHz and for a refractive index n=1 (such as for an air or inert gas filled cavity), then the cavity will have a physical length L2 of about 3 mm, which provides a 3 mm optical path length corresponding to 50 GHz. For a cavity material such as glass, e.g., n=1.5, then the physical length will be around 2 mm to provide the optical path length of 2 mm×1.5=3 mm, again corresponding to a 50 GHz mode spacing.

The distance L2 and thus the cavity length may be increased to reduce the mode-spacing. For example, by doubling the cavity length, e.g., to 4-6 mm, the mode-spacing may be reduced to 25 GHz, or by again doubling the cavity length, e.g., to 8-12 mm, the mode-spacing may be reduced to 12.5 GHz. The mode-spacing may be increased, if desired, by alternatively reducing the cavity length, e.g., by reducing the cavity length to half, e.g., 1-1.5 mm to increase the mode-spacing to 100 GHz. Generally, the mode-spacing may be advantageously selected by adjusting the cavity to a corresponding cavity length. The device of the preferred embodiment may utilize other means for reducing the mode-spacing as understood by those skilled in the art.

This extension of cavity length from that of a conventional VCSEL is permitted by the removal or partial removal of a mirrored reflector surface of the mirror M2 and inclusion of mirror M3. The light source 100 and in particular the mirror M3 may be formed as disclosed in co-pending application No. 09/817,362, filed Mar. 20, 2001, and assigned to the same assignee of the present application, and incorporated by reference as though set forth fully herein.

The extension of the external cavity out to 1.5-15 mm permits a 10-100 GHz mode spacing, since the cavity will support a number of modes having a spacing that depends on the inverse of the cavity length (i.e., c/2 nL, where n is the refractive index of the cavity material and L is the cavity length). The VCSEL with external cavity device according to a preferred embodiment herein is preferably configured for use in the telecom band around 1550 nm, and alternatively with the telecom short distance band around 1300 nm or the very short range 850 nm band. In the 1550 nm band, 100, 50 and 12.5 GHz cavities are of particular interest as they correspond to standard DWDM channel spacings.

The light source 100 may be around 15 microns tall and preferably comprises a gain medium of InGaAsP or InGaAs and InGaAlAs or In GaAsP or AlGaAs mirrors (or mirrors formed of other materials according to desired wavelengths as taught, e.g., in Wilmsen, Temkin and Coldren, et al., “Vertical Cavity Surface Emitting Lasers, 2nd edition, Chapter 8).

The light source 100 may be formed in a variety of manners. For example, the second mode spacing cavity may be formed by a solid lens of either conventional or gradient index design, and may be formed of glass. When a gradient index lens is used, the index of refraction of the material filling the cavity varies (e.g., decreases) with distance from the center optical axis of the resonant cavity. Such GRIN lens provides efficient collection of the strongly divergent light emitted from the laser cavity. In an embodiment using a GRIN lens, the mirrored surface of mirror M3 may be curved or flat, depending on design considerations.

The mirror M3 may have one or more coatings on its remote surface such that it efficiently reflects incident light emitted from the VCSEL 101 as a resonator reflector, preferably around 1550 nm for the telecom band. The mirror M3 is preferably formed of alternating high and low refractive index materials to build up a high reflectivity, such as alternating quarter-wavelength layers of TiO2/SiO2 or other such materials known to those skilled in the art.

The radius of curvature of may be around the length the second cavity. Emitted radiation from the VCSEL 101 diverging outward from the gain region will be substantially reflected directly back into the gain region when the radius of curvature is approximately the cavity length, or around 2-3 mm for a 50 GHz mode-spacing device.

In operation, the cavities provide one or more resonant nodes at optical frequencies for which the roundtrip gain exceeds the loss. For a longer cavity such as the external cavity, the resonant modes form a comb of frequencies having a separation inversely proportional to the cavity length. For example, for a cavity optical length of 3 mm, the optical spacing of the modes is approximately 50 GHz. Thus, many such nodes will fit within the gain bandwidth of the gain material.

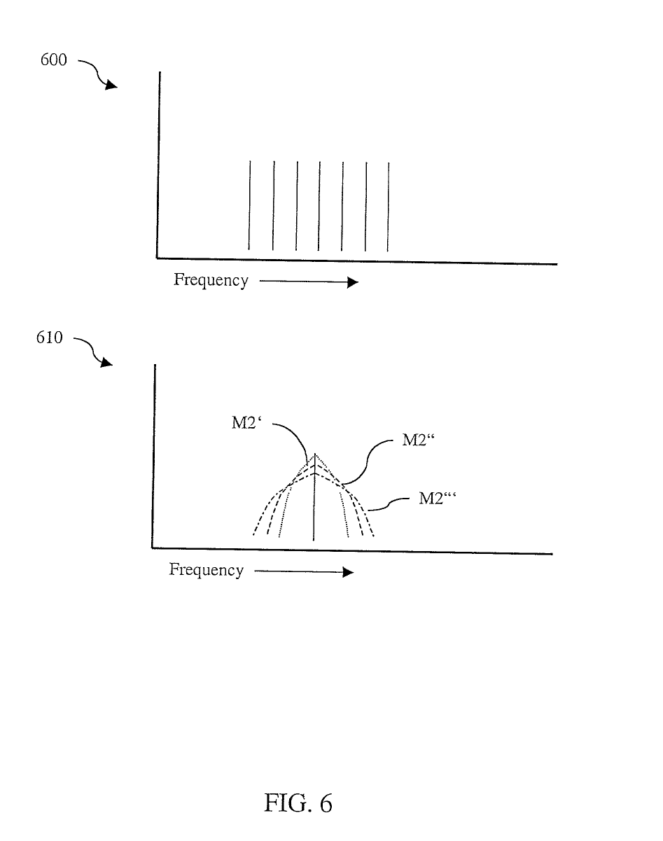

FIG. 6 is a conceptual plot showing how the reflectivity of M2 may be adjusted to achieve mode selectivity. FIG. 6 includes the resonant modes of an external cavity 600 plotted above the resonant mode of a VCSEL gain cavity 610 along a common frequency axis. FIG. 6 further shows how varying the reflectivity of the gain cavity may result in different responses M2′, M2″, and M2′″. By analogy to the electrical arts, by varying the Q of the gain cavity, the resonant bandwidth of the gain cavity may be selected advantageously. As the reflectivity of the mirror is reduces, the resonance flattens out, as in a lower-Q circuit.

As will be appreciated from FIG. 6, by varying the reflectivity of M2, the spectral bandwidth of the gain cavity may be chosen so as to have a predetermined response shape

The above properties of the light source can be utilized as a single-frequency light source to provide for a simpler precision frequency source for DWDM applications by incorporating the wavelocker function into the cavity of a semiconductor laser, thereby eliminating the need for an external wavelocker.

The composite mirror system disclosed above can be designed to an optimal number of Fabry-Perot modes within the lasing spectrum. The relative values of M1, M2 and M3, as well as the length of the external cavity, may be configured such that the number of lasing modes reduces to one. Under these circumstances, the laser wavelength of operation will be determined substantially by the spacing between the two mirrors M2 and M3 (L2).

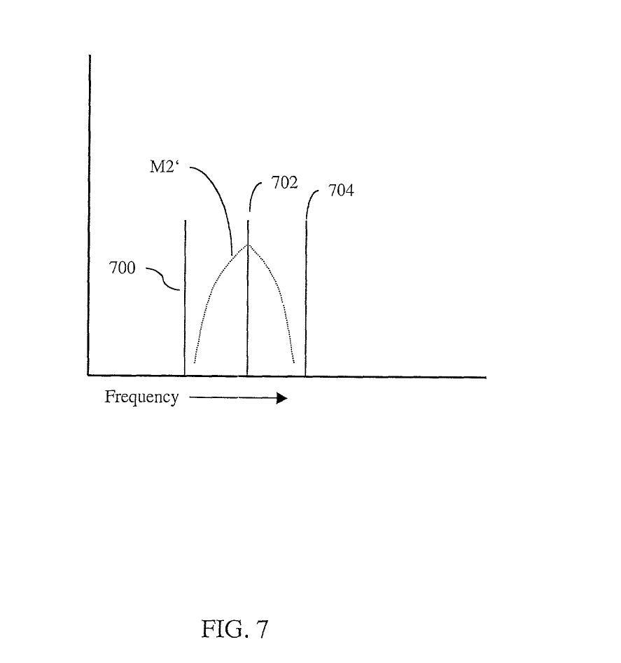

FIG. 7 illustrates the effect of the sharpness of the gain cavity on mode selection. In FIG. 7, three external cavity modes 700, 702, and 704 are plotted. As mentioned above, the spacing of the three modes of FIG. 7 may be determined by the spacing of mirrors M2 and M3. The desired resonant mode of the external cavity may be characterized as a contiguous plurality of desired modes of operation interspersed in frequency between undesired modes of operation.

It should be noted that the peak of gain cavity response shape M2′ may first be brought into alignment with a desired external cavity mode. This may be accomplished through temperature control, for example.

In this example, it is desired to select mode 702. To select mode 702, the gain envelope M2′ must properly align with mode 702. In one embodiment, the Q of M2 may be increased so as to precisely select one of the external cavity modes. Thus, as shown in FIG. 7, the properties of M2 may be adjusted so as to select a predetermined external cavity mode.

Either the properties of the external cavity or the gain cavity may be configured to achieve mode selection. For example, L2 may be shortened so as to space the modes sufficiently apart, and M2 may be configured so as to have a high Q. However, the modes of the external cavity are fairly fixed, so the gain cavity alone may be configured advantageously.

As will be appreciated from FIG. 7, the gain envelope M2′ may be configured such that the frequency extremes do not overlap with a neighbor mode. Thus, in one embodiment, the extremes of M2′ do not overlap with either mode 700 or 704. By having the gain envelope so configured, the unintentional selection of a neighbor mode will not occur.

However, as the light source is put into use, the response shape M2′ may drift in frequency towards an undesired mode such as modes 700 or 704. In configuring the light source of this disclosure, it is desired to have the shape, or “skirt”, of M2′ as wide as possible to ensure selection of the desired mode. However, the skirt of M2′ should not be so wide so as to unintentionally select an undesired mode should the response of the gain drift in operation.

It is contemplated that a small degree of overlap between the gain cavity response and an undesired mode may be acceptable. One example of acceptable overlap is the case where an undesired mode intersects with a portion of the gain cavity response at a low enough level such that lasing does not occur. Thus, in a further preferred embodiment, the response shape of the gain cavity may be chosen such that the extremes of the response shape only overlap with neighbor modes to a degree that does not enable lasing. The amount of acceptable overlap may be determined on a case-by-case basis depending on the intended application, or other factors such as environmental conditions.

Since the effective spacing between these mirrors can be fabricated to a very high tolerance, the frequency of operation can be determined to a very high tolerance. It is contemplated that the external cavity may be fabricated from a wide variety of materials. For example, in one embodiment, the spacer material forming the external cavity may be filled with a gas. If the spacer material between the mirrors M2 and M3 is a gas, providing for constant gas density will ensure constant mode spacing, i.e. by providing for leak free hermetic sealing.

If the spacer material between the two mirrors M2 and M3 is a transparent solid, such as disclosed above, the hermeticity constraint may be relaxed. However, temperature control may be desired to eliminate the change of cavity length L due to changes in temperature. This does not add significantly to the system cost, since all lasers for DWDM applications typically require some temperature control of the laser.

As lasers age they require ever-higher current to maintain constant power output. As the current increases the laser temperature increases and the index of refraction changes. Both of these effects change the wavelength of emission. In devices of the prior art, an external wavelocker is used to detect this change in wavelength and compensate, typically by changing the temperature of the laser. In the device of this invention, the wavelength is no longer determined by the laser gain region and mirrors M1 and M2, rather it is determined by the external cavity formed by M2 and M3. Since no current flows in this region, changes in the current have no effect. Furthermore, the external cavity consists of materials (glass or air) whose properties are stable over time. As a result the wavelength of the laser of this invention is stable and required no external wavelocker,

The wavelength changes described above and eliminated by this invention occur slowly over time. By contrast, chirp occurs within the duration of a single light pulse. However, the source of the phenomena remains a current induced change in the refractive index of the semiconductor laser material. Since the wavelength or frequency of operation is determined predominately by the external cavity, and since the external cavity is not effected by the modulated current through the semiconductor VCSEL, there will be little chirping.

Although the frequency or wavelength of operation is determined predominately by the external cavity, since the reflectivity of mirror M2 must be less that 100% the internal cavity does exert some influence. The degree of influence is proportional to the ratio of the length of the internal cavity to the length of the external cavity. Thus the designer can control the degree of wavelength stability or chirp reduction by adjusting this ratio. Although, generally it is desirable to minimize these quantities, the ability to do this will be limited by practical constraints such as total device size or cost, which will vary from application to application. Because of their short internal cavity, a VCSEL-based device is a preferred embodiment of this invention.

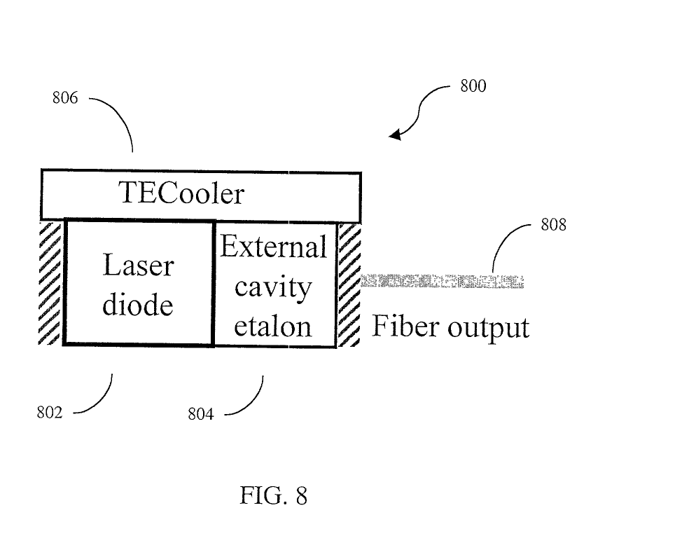

FIG. 8 shows a schematic diagram of a DWDM laser device having an integrated wavelocker and configured in accordance with the teachings of this disclosure. As will be appreciated from FIG. 8, the laser diode 802 and external etalon 804 may both be disposed within the TEC cooler 806. Thus, the requirement for an external wavelocker has been eliminated.

Additionally, since the external wavelocker has been eliminated, no light output from the output port 808 need be tapped off.

The single frequency integrated laser and wavelocker of the present disclosure has an additional important property in that the wavelength of emission remains stable in the presence of fluctuations in the internal dynamics of the laser. As mentioned above, a particular problem in conventional lasers when directly modulated is that “chirp”, or frequency change with time and drive current level, limits the distance over which the resulting optical signal can be propagated before dispersion becomes excessive. Due to the frequency stability of the disclosed external cavity, chirp is dramatically reduced in this device.

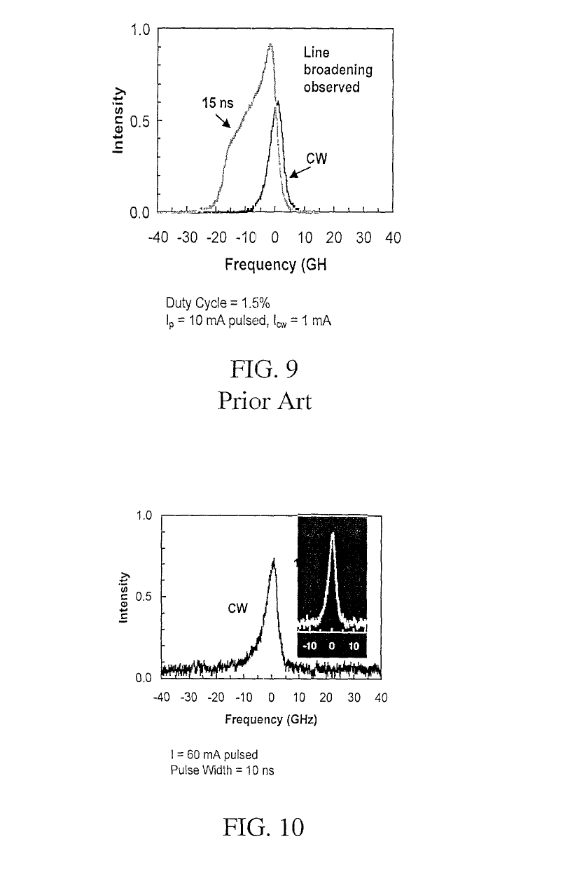

The plots of FIGS. 9 and 10 illustrates this effect under laboratory conditions. FIG. 9 shows the emission spectrum both unmodulated and under pulsed modulation for a conventional VCSEL. The large increase in spectral extent with modulation is evident. FIG. 10 shows the device of FIG. 8 when similarly modulated. As will be appreciated by those skilled in the art, no measurable increase in spectral width as a result of the modulation is observed.

As will be appreciated by comparing FIGS. 9 and 10, chirp, as measured by the full width at half maximum line width has been decreased by more than a factor of 2 in the light source configured in accordance with this disclosure.

Thus, the light source as disclosed above has been adapted for use in the case of a single-frequency or single channel wavelength laser. A single channel laser has been disclosed with wavelength precision sufficient to eliminate the need for an external wavelocker. A single-channel laser has been disclosed with an external cavity capable of being directly modulated in a chirp-free manner.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

what is claimed is:

1. A light source comprising:
a gain region defined by a first and second mirror, said gain region having a corresponding response shape;
an external cavity defined by a third mirror and said second mirror, said external cavity having a plurality of resonant modes; and
wherein said second mirror is formed such that said response shape of said gain region selects a single one of said plurality of modes.

2. The light source of claim 1, wherein said first mirror and the gain region is fabricated for use in the wavelength range of approximately 780-790 nm.

3. The light source of claim 1, wherein said first mirror and the gain region is fabricated for use in the wavelength range of approximately 1300-1700 nm.

4. The light source of claim 1, wherein said gain region response shape has a nominal peak wavelength of approximately 1550 nm.

5. The light source of claim 1, wherein said external cavity is greatly extended in length compared to said gain region.

6. The light source of claim 1, wherein the length of said external cavity has a length of approximately 2-3 mm.

7. The light source of claim 1, wherein said plurality of resonant modes have a mode spacing of approximately 100 GHz.

8. The light source of claim 1, wherein said plurality of resonant modes have a mode spacing of approximately 50 GHz.

9. The light source of claim 1, wherein said external cavity is filled with air and has a length of approximately 3 mm.

10. The light source of claim 1, wherein said external cavity comprises glass and has a length of approximately 2 mm.

11. The light source of claim 1, wherein the length of said external cavity has a length of approximately 4-6 mm.

12. The light source of claim 1, wherein said plurality of resonant modes have a mode spacing of approximately 25 GHz.

13. The light source of claim 1, wherein the length of said external cavity has a length of approximately 8-12 mm.

14. The light source of claim 1, wherein said plurality of resonant modes have a mode spacing of approximately 12.5 GHz.

15. The light source of claim 1, wherein said light source is configured for use in the wavelength range of 1550 nm.

16. The light source of claim 15, wherein said external cavity is configured to provide mode spacing corresponding to standard DWDM channel spacings.

17. The light source of claim 16, wherein said external cavity provides a mode spacing of 12.5 GHz.

18. The light source of claim 16, wherein said external cavity provides a mode spacing of 50 GHz.

19. The light source of claim 16, wherein said external cavity provides a mode spacing of 100 GHz.

20. The light source of claim 1, wherein said third mirror is configured to reflect incident light in the 1550 nm telcom band.

21. The light source of claim 1, wherein said third mirror has a radius of curvature equal to the length of said external cavity.

22. The light source of claim 1, wherein the relative reflectivity values of said first, second, and third mirrors, and the length of said external cavity are configured to reduce the number of lasing modes to one.

23. The light source of claim 1, wherein the light source may operate as a single-frequency light source without the need for an external wavelocker.

24. The light source of claim 1, wherein the properties of said second mirror may be adjusted so as to select a predetermined one of said plurality of external cavity resonant modes.

25. The light source of claim 1, wherein said single one of said plurality of resonant modes comprises a desired mode of operation interspersed in frequency between undesired modes of operation.

26. The light source of claim 25, wherein said desired mode of operation is selected such that said response shape of said gain region does not overlap in frequency with either of said undesired modes of operation.

27. The light source of claim 25, wherein said desired mode of operation is selected such that said response shape of said gain region overlaps in frequency with either of said undesired modes of operation to a degree insufficient to enable lasing.

28. The light source of claim 1, wherein the change of wavelength caused by modulation of said light source is reduced by a factor greater than or equal to 2 as compared to a similar light source without the external cavity.

29. A light source comprising:
a gain region defined by a first and second mirror, said gain region having a corresponding response shape;
an external cavity defined by a third mirror and said second mirror, said external cavity having a plurality of resonant modes including a desired mode of operation and at least one undesired mode of operation; and
wherein said second mirror is formed such that said response shape of said gain region selects said desired mode of operation while not selecting said at least one undesired mode of operation.

30. The light source of claim 29, wherein said first mirror and the gain region is fabricated for use in the wavelength range of approximately 780-790 nm.

31. The light source of claim 29, wherein said first mirror and the gain region is fabricated for use in the wavelength range of approximately 1300-1700 nm.

32. The light source of claim 29, wherein said gain region response shape has a nominal peak wavelength of approximately 1550 nm.

33. The light source of claim 29, wherein said external cavity is greatly extended in length compared to said gain region.

34. The light source of claim 29, wherein the length of said external cavity has a length of approximately 2-3 mm.

35. The light source of claim 29, wherein said plurality of resonant modes have a mode spacing of approximately 100 GHz.

36. The light source of claim 29, wherein said plurality of resonant modes have a mode spacing of approximately 50 GHz.

37. The light source of claim 29, wherein said external cavity is filled with air and has a length of approximately 3 mm.

38. The light source of claim 29, wherein said external cavity comprises glass and has a length of approximately 2 mm.

39. The light source of claim 29, wherein the length of said external cavity has a length of approximately 4-6 mm.

40. The light source of claim 29, wherein said plurality of resonant modes have a mode spacing of approximately 25 GHz.

41. The light source of claim 29, wherein the length of said external cavity has a length of approximately 8-12 mm.

42. The light source of claim 29, wherein said plurality of resonant modes have a mode spacing of approximately 12.5 GHz.

43. The light source of claim 29, wherein said light source is configured for use in the wavelength range of 1550 nm.

44. The light source of claim 43, wherein said external cavity is configured to provide mode spacing corresponding to standard DWDM channel spacings.

45. The light source of claim 44, wherein said external cavity provides a mode spacing of 12.5 GHz.

46. The light source of claim 44, wherein said external cavity provides a mode spacing of 50 GHz.

47. The light source of claim 44, wherein said external cavity provides a mode spacing of 100 GHz.

48. The light source of claim 29, wherein said third mirror is configured to reflect incident light in the 1550 nm telcom band.

49. The light source of claim 29, wherein said third mirror has a radius of curvature equal to the length of said external cavity.

50. The light source of claim 29, wherein the relative reflectivity values of said first, second, and third mirrors, and the length of said external cavity are configured to reduce the number of lasing modes to one.

51. The light source of claim 29, wherein the light source may operate as a single-frequency light source without the need for an external wavelocker.

52. The light source of claim 29, wherein the properties of said second mirror may be adjusted so as to select a predetermined one of said plurality of external cavity resonant modes.

53. The light source of claim 29, wherein said single one of said plurality of resonant modes comprises a desired mode of operation interspersed in frequency between undesired modes of operation.

54. The light source of claim 53, wherein said desired mode of operation is selected such that said response shape of said gain region does not overlap in frequency with either of said undesired modes of operation.

55. The light source of claim 53, wherein said desired mode of operation is selected such that said response shape of said gain region overlaps in frequency with either of said undesired modes of operation to a degree insufficient to enable lasing.

56. The light source of claim 29, wherein the change of wavelength caused by modulation of said light source is reduced by a factor greater than or equal to 2 as compared to a similar light source without the external cavity.

57. A light source comprising:
a gain region defined by a first and second mirror, said gain region having a corresponding response shape;
an external cavity defined by a third mirror and said second mirror, said external cavity having a plurality of resonant modes including a desired mode of operation interspersed in frequency between undesired modes of operation; and
wherein said gain region is formed such that said response shape of said gain region selects said desired mode of operation while not overlapping in frequency with said undesired modes of operation.

58. The light source of claim 57, wherein said first mirror and the gain region is fabricated for use in the wavelength range of approximately 780-790 nm.

59. The light source of claim 57, wherein said first mirror and the gain region is fabricated for use in the wavelength range of approximately 1300-1700 nm.

60. The light source of claim 57, wherein said gain region response shape has a nominal peak wavelength of approximately 1550 nm.

61. The light source of claim 57, wherein said external cavity is greatly extended in length compared to said gain region.

62. The light source of claim 57, wherein the length of said external cavity has a length of approximately 2-3 mm.

63. The light source of claim 57, wherein said plurality of resonant modes have a mode spacing of approximately 100 GHz.

64. The light source of claim 57, wherein said plurality of resonant modes have a mode spacing of approximately 50 GHz.

65. The light source of claim 57, wherein said external cavity is filled with air and has a length of approximately 3 mm.

66. The light source of claim 57, wherein said external cavity comprises glass and has a length of approximately 2 mm.

67. The light source of claim 57, wherein the length of said external cavity has a length of approximately 4-6 mm.

68. The light source of claim 57, wherein said plurality of resonant modes have a mode spacing of approximately 25 GHz.

69. The light source of claim 57, wherein the length of said external cavity has a length of approximately 8-12 mm.

70. The light source of claim 57, wherein said plurality of resonant modes have a mode spacing of approximately 12.5 GHz.

71. The light source of claim 57, wherein said light source is configured for use in the wavelength range of 1550 nm.

72. The light source of claim 71, wherein said external cavity is configured to provide mode spacing corresponding to standard DWDM channel spacings.

73. The light source of claim 72, wherein said external cavity provides a mode spacing of 12.5 GHz.

74. The light source of claim 72, wherein said external cavity provides a mode spacing of 50 GHz.

75. The light source of claim 72, wherein said external cavity provides a mode spacing of 100 GHz.

76. The light source of claim 57, wherein said third mirror is configured to reflect incident light in the 1550 nm telcom band.

77. The light source of claim 57, wherein said third mirror has a radius of curvature equal to the length of said external cavity.

78. The light source of claim 57, wherein the relative reflectivity values of said first, second, and third mirrors, and the length of said external cavity are configured to reduce the number of lasing modes to one.

79. The light source of claim 57, wherein the light source may operate as a single-frequency light source without the need for an external wavelocker.

80. The light source of claim 57, wherein the properties of said second mirror may be adjusted so as to select a predetermined one of said plurality of external cavity resonant modes.

81. The light source of claim 57, wherein said desired mode of operation is selected such that said response shape of said gain region does not overlap in frequency with either of said undesired modes of operation.

82. The light source of claim 57, wherein said desired mode of operation is selected such that said response shape of said gain region overlaps in frequency with either of said undesired modes of operation to a degree insufficient to enable lasing.

83. The light source of claim 57, wherein the change of wavelength caused by modulation of said light source is reduced by a factor greater than or equal to 2 as compared to a similar light source without the external cavity.

84. A light source comprising:
a gain region defined by a first and second mirror, said gain region having a corresponding response shape;
an external cavity defined by a third mirror and said second mirror, said external cavity having a plurality of resonant modes including a desired mode of operation interspersed in frequency between undesired modes of operation; and
wherein said gain region is formed such that said response shape of said gain region selects said desired mode of operation such that said undesired modes of operation do not operate.

85. The light source of claim 84, wherein said first mirror and the gain region is fabricated for use in the wavelength range of approximately 780-790 nm.

86. The light source of claim 84, wherein said first mirror and the gain region is fabricated for use in the wavelength range of approximately 1300-1700 nm.

87. The light source of claim 84, wherein said gain region response shape has a nominal peak wavelength of approximately 1550 nm.

88. The light source of claim 84, wherein said external cavity is greatly extended in length compared to said gain region.

89. The light source of claim 84, wherein the length of said external cavity has a length of approximately 2-3 mm.

90. The light source of claim 84, wherein said plurality of resonant modes have a mode spacing of approximately 100 GHz.

91. The light source of claim 84, wherein said plurality of resonant modes have a mode spacing of approximately 50 GHz.

92. The light source of claim 84, wherein said external cavity is filled with air and has a length of approximately 3 mm.

93. The light source of claim 84, wherein said external cavity comprises glass and has a length of approximately 2 mm.

94. The light source of claim 84, wherein the length of said external cavity has a length of approximately 4-6 mm.

95. The light source of claim 84, wherein said plurality of resonant modes have a mode spacing of approximately 25 GHz.

96. The light source of claim 84, wherein the length of said external cavity has a length of approximately 8-12 mm.

97. The light source of claim 84, wherein said plurality of resonant modes have a mode spacing of approximately 12.5 GHz.

98. The light source of claim 84, wherein said light source is configured for use in the wavelength range of 1550 nm.

99. The light source of claim 98, wherein said external cavity is configured to provide mode spacing corresponding to standard DWDM channel spacings.

100. The light source of claim 99, wherein said external cavity provides a mode spacing of 12.5 GHz.

101. The light source of claim 99, wherein said external cavity provides a mode spacing of 50 GHz.

102. The light source of claim 99, wherein said external cavity provides a mode spacing of 100 GHz.

103. The light source of claim 84, wherein said third mirror is configured to reflect incident light in the 1550 nm telcom band.

104. The light source of claim 84, wherein said third mirror has a radius of curvature equal to the length of said external cavity.

105. The light source of claim 84, wherein the relative reflectivity values of said first, second, and third mirrors, and the length of said external cavity are configured to reduce the number of lasing modes to one.

106. The light source of claim 84, wherein the light source may operate as a single-frequency light source without the need for an external wavelocker.

107. The light source of claim 84, wherein the properties of said second mirror may be adjusted so as to select a predetermined one of said plurality of external cavity resonant modes.

108. The light source of claim 84, wherein said single one of said plurality of resonant modes comprises a desired mode of operation interspersed in frequency between undesired modes of operation.

109. The light source of claim 108, wherein said desired mode of operation is selected such that said response shape of said gain region does not overlap in frequency with either of said undesired modes of operation.

110. The light source of claim 108, wherein said desired mode of operation is selected such that said response shape of said gain region overlaps in frequency with either of said undesired modes of operation to a degree insufficient to enable lasing.

111. The light source of claim 99, wherein the change of wavelength caused by modulation of said light source is reduced by a factor greater than or equal to 2 as compared to a similar light source without the external cavity.

112. A light source comprising:
a gain region defined by a first and second mirror, said gain region having a corresponding response shape;
an external cavity defined by a third mirror and said second mirror, said external cavity having a plurality of resonant modes;
wherein said second mirror is formed such that said response shape of said gain region selects a single one of said plurality of modes; and
wherein said light source may be operated at said selected mode without the use of an external wavelocker.
